(19) United States
(12) Patent Application Publication
(10) Pub. No.: US 2013/0149916 A1
(43) Pub. Date: Jun. 13, 2013

(54) PIN AND PLUG HAVING THE PIN

(71) Applicants: YI-CHEN CHEN, TAIPEI CITY (TW); CHIH-YUNG CHOU, TAIPEI CITY (TW); CHING-FENG HSIEH, TAIPEI CITY (TW)

(72) Inventors: YI-CHEN CHEN, TAIPEI CITY (TW); CHIH-YUNG CHOU, TAIPEI CITY (TW); CHING-FENG HSIEH, TAIPEI CITY (TW)

(73) Assignees: ASKEY COMPUTER CORP.; ASKEY TECHNOLOGY (JIANGSU) LTD.

(21) Appl. No.: 13/365,289

(22) Filed: Feb. 3, 2012

(30) Foreign Application Priority Data
Dec. 13, 2011 (TW) 100223512

(51) Int. Cl. H01R 13/24; H01R 13/428

(52) U.S. Cl. 439/700; 439/744

(57) ABSTRACT

A pin and a plug having the pin allow a body of the plug to enclose the pin integrally. The plug includes the body and the pin. The body has a receiving space therein for receiving the fixing segment. An insulation portion extends outward from the external surface of the body. The pin is plate-shaped and defined with an inserting segment, a fixing segment, and a burying segment therebetween. The burying segment has a burial hole and barbs, and is buried in the insulation portion. The fixing segment protrudes into the receiving space. The inserting segment is exposed from the insulation portion. The pin and the plug cut costs, speed up a manufacturing process thereof, and allow the body to be formed by a single injection molding process and thus enclose and fix the pin in place firmly.

### CROSS-REFERENCE TO RELATED APPLICATION

This non-provisional application claims priority under 35 U.S.C. §119(a) on Patent Application No(s). 100223512 filed in Taiwan, R.O.C. on Dec. 13, 2011, the entire contents of which are hereby incorporated by reference.

### FIELD OF TECHNOLOGY

The present invention relates to pins and plugs having the pins, and more particularly, to a pin and a plug having the pin which can be manufactured by a single injection molding process.

### BACKGROUND

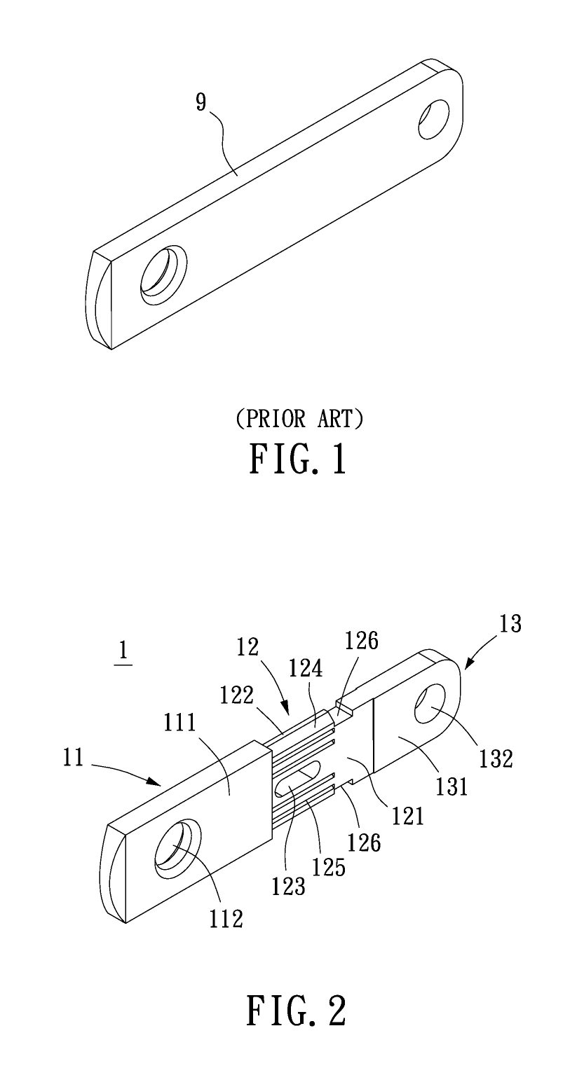

Prevalence of electric appliances is accompanied by diversity of electric appliances. Plugs, which are indispensable to electric appliances, are of vital importance to user safety. FIG. 1 is a perspective view of a conventional pin 9. As shown in FIG. 1, the pin 9 of a conventional plug is flat. However, in an attempt to form and fix the pin 9 to a body of the conventional plug (not shown), a single injection molding fails to enable the conventional body to enclose the pin 9 and fix the pin 9 in place; instead, the other portion of the conventional body has to be formed by an injection molding process first, and then an insulation portion (not shown) of the conventional body has to be formed by another ensuing injection molding process so as to enclose the pin 9 and fix the pin 9 in place. In doing so, the prior art not only incurs costs in developing dices and manufacturing, but also renders the manufacturing process lengthy. In addition, the pin 9 of the conventional plug is flat, and thus the pin 9 cannot be firmly fixed to the insulation portion of the conventional body.

Accordingly, it is imperative to devise a pin and a plug having the pin with a view to reducing the incurred costs, speeding up a manufacturing process thereof, allowing the pin and the plug to be manufactured by a single injection molding process, and ensuring that the pin can be firmly fixed to a body of the plug and enclosed therein.

### SUMMARY

In view of the aforesaid drawbacks of the prior art, the inventor of the present invention conducted extensive researches and experiments according to the inventor's years of experience in the related industry, and finally developed a pin and a plug having the pin with a view to cutting manufacturing costs thereof and speeding up a manufacturing process thereof.

The pin and the plug having the pin of the present invention are manufactured by a single injection molding process, and the pin can be firmly fixed in place and enclosed.

In order to achieve the above and other objectives, the first aspect of the present invention provides a pin which is disposed at a body and is plate-shaped. The pin is characterized in that: the pin is defined with an inserting segment, a fixing segment, and a burying segment therebetween, and the burying segment has a burial hole and barbs and is enclosed by an outward-extending external surface of the body.

The second aspect of the present invention provides a plug, comprising: a body having a receiving space therein for receiving the fixing segment, and an insulation portion extending outward from an external surface of the body; and a pin being plate-shaped and defined with an inserting segment, a fixing segment, and a burying segment therebetween, the burying segment having a burial hole and barbs and being buried in the insulation portion.

Accordingly, the present invention provides a pin and a plug having the pin to not only cut costs and speed up the manufacturing process thereof but also allow a body of the plug to be thoroughly processed in a single injection molding process so as to enclose the pin and fix the pin in place firmly.

### BRIEF DESCRIPTION

Objectives, features, and advantages of the present invention are hereunder illustrated with specific embodiments in conjunction with the accompanying drawings, in which:

FIG. 1 (PRIOR ART) is a perspective view of a conventional pin;

FIG. 2 is a perspective view of a pin according to an embodiment of the present invention;

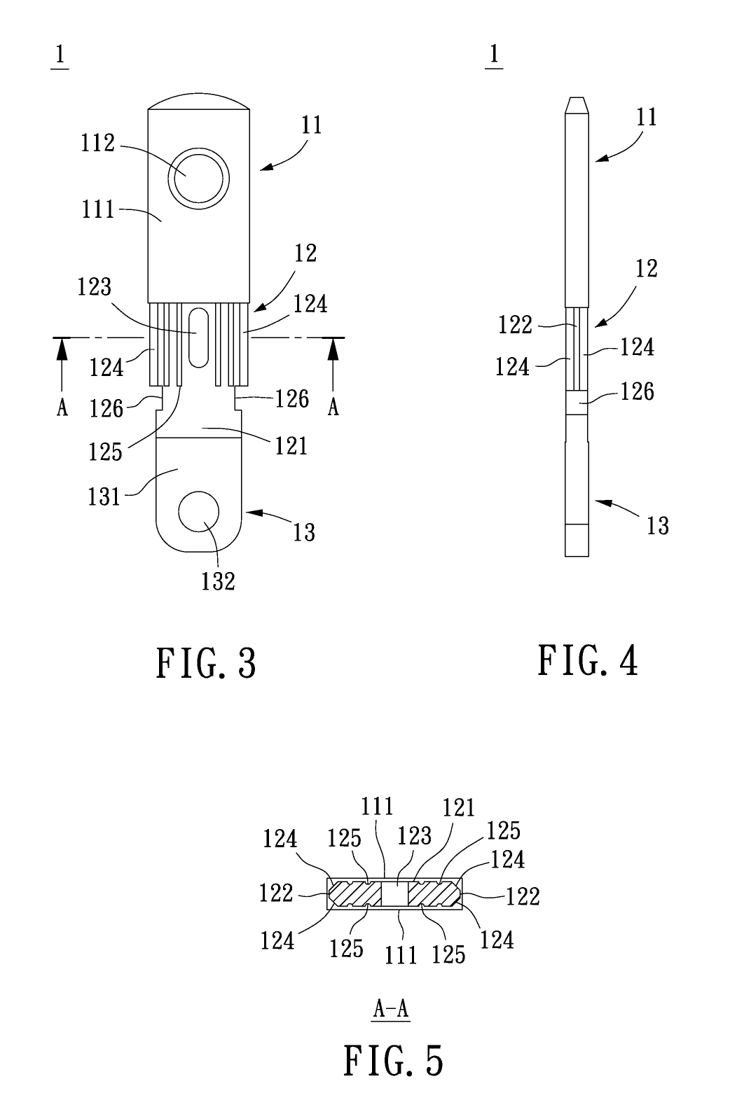

FIG. 3 is a top view of the pin according to an embodiment of the present invention;

FIG. 4 is a side view of the pin according to an embodiment of the present invention;

FIG. 5 is a cross-sectional view of the pin taken along line A-A of FIG. 3;

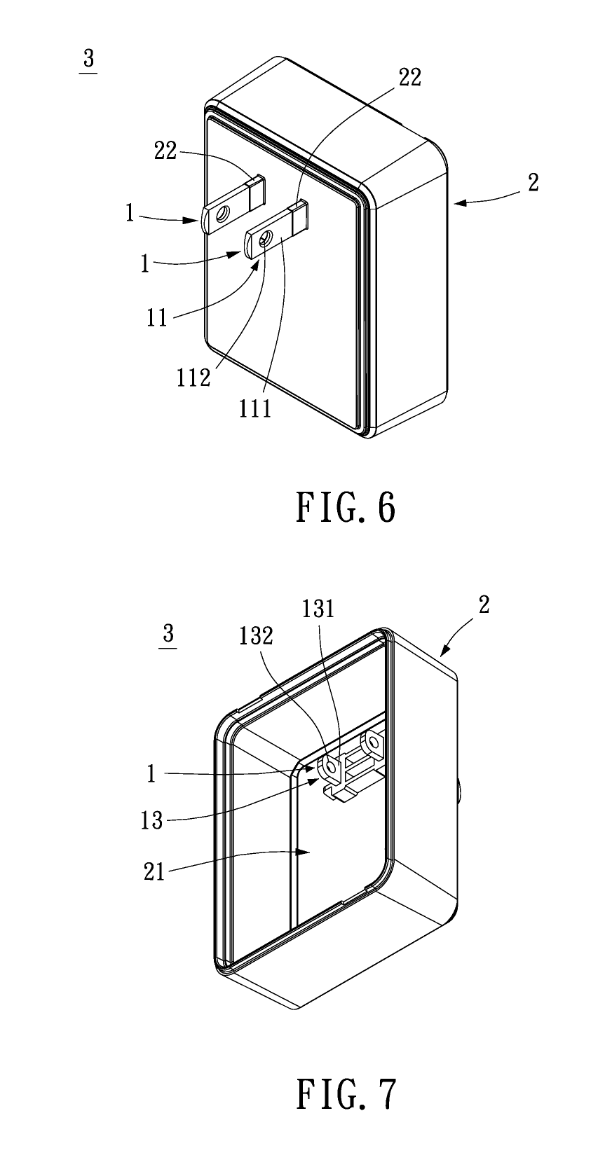

FIG. 6 is a perspective view of a plug having the pins according to another embodiment of the present invention;

FIG. 7 is another perspective view of the plug having the pins according to another embodiment of the present invention;

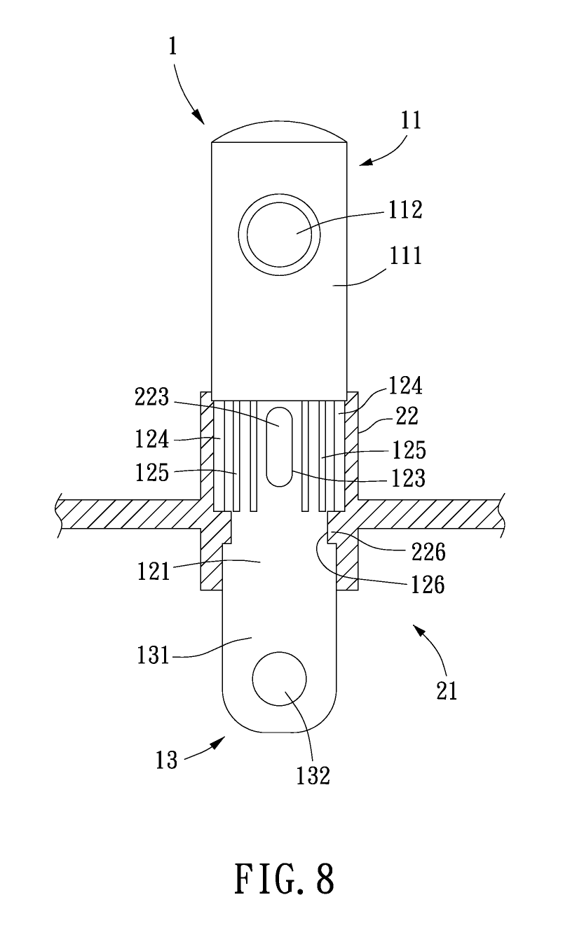

FIG. 8 is a schematic view of a burying segment buried in an insulation portion of a body according to another embodiment of the present invention;

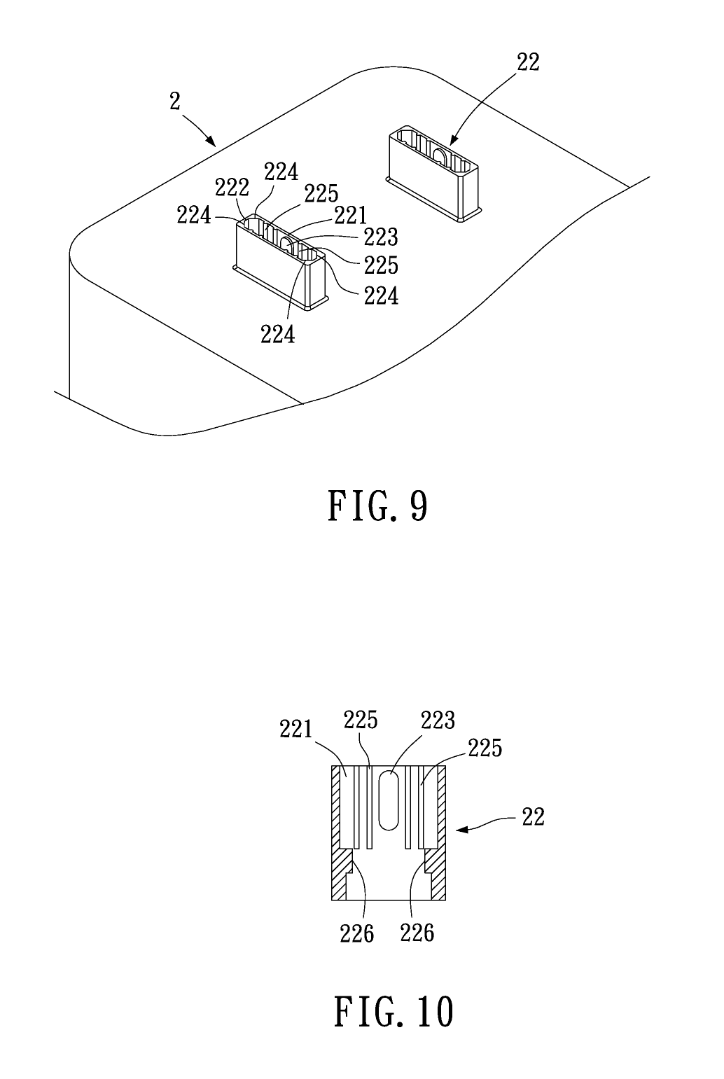

FIG. 9 is a schematic view of the insulation portion of the body according to another embodiment of the present invention; and

FIG. 10 is a cross-sectional view of the insulation portion according to another embodiment of the present invention.

### DETAILED DESCRIPTION

Referring to FIG. 2 through FIG. 5, there are shown a perspective view, a top view, a side view, and a cross-sectional view of 1 pin 1 according to an embodiment of the present invention. As shown in the drawings, in the first aspect of the present invention, the pin 1 is applicable to a body (not shown). The pin 1 is plate-shaped and defined with an inserting segment 11, a fixing segment 13, and a burying segment 12 therebetween. The inserting segment 11, the burying segment 12, and the fixing segment 13 are flat. The thickness of the burying segment 12 is less than the thickness of the inserting segment 11, and the burying segment 12 adjoins the inserting segment 11; hence, a stepped structure is formed between each of two opposing first surfaces 111 of the inserting segment 11 which together define the thickness thereof and a corresponding one of two opposing first surfaces 121 of the burying segment 12 which together define the thickness thereof. A burial hole 123 is formed in the burying segment 12 to penetrate the burying segment 12 and open at the two opposing first surfaces 121 of the burying segment 12. The burial hole 123 is oblong and its length varies with that of the burying segment 12. Two opposing second surfaces 122 of the burying segment 12 each adjoin and separate the two opposing first surfaces 121 of the burying segment 12. A barb 124 is formed between each said first surface 121 and each said second surface 122. In this embodiment, four said barbs 124 are provided. However, the quantity of the barbs 124 of the present invention is subject to changes as needed. The thickness of the fixing segment 13 is larger than the thickness of the burying segment 12, and the fixing segment 13 adjoins the burying segment 12; hence, a stepped structure is formed between each of two opposing first surfaces 121 of the burying segment 12 and a corresponding one of two opposing first surfaces 131 of the fixing segment 13 which together define the thickness thereof.

Referring to FIG. 6 through FIG. 10, an injection molding process for forming the pin 1 at a body 2 comprises the steps of: enclosing the burying segment 12 by an injection molding die (not shown) for the body 2; forming a filling space (not shown) adapted to contain a liquid plastic material therein between the burying segment 12 and the injection molding die; and filling the filling space with the liquid plastic material (not shown). With the burying segment 12 being equipped with the barbs 124, a relatively spacious flow channel is formed between the burying segment 12 and the injection molding die to allow the liquid plastic material to fill the filling space smoothly. Afterward, the liquid plastic material sets and turns into a solid plastic material for forming an insulation portion 22 at the periphery of the burying segment 12. With the burying segment 12 having the burial hole 123, a portion of the liquid plastic material fills the burial hole 123 and sets therein to turn into a solid plastic material for fixing the pin 1 to the body 2. As mentioned earlier, a stepped structure is formed between each of two opposing first surfaces 111 of the inserting segment 11 and a corresponding one of two opposing first surfaces 121 of the burying segment 12, and a stepped structure is formed between each of two opposing first surfaces 121 of the burying segment 12 and a corresponding one of two opposing first surfaces 131 of the fixing segment 13; hence, the liquid plastic material sets and turns into a solid plastic material whereby the pin 1 is fixed to the stepped structures, thereby allowing the pin 1 to be fixed to the body 2 more firmly. Last but not least, the liquid plastic material sets and forms the body 2. Due to the barbs 124, the liquid plastic material sets and forms the insulation portion 22 at the periphery of the burying segment 12, such that the insulation portion 22 and the body 2 are integrally formed as a unitary structure. The fixing segment 13 protrudes into the body 2 to connect with other components (not shown) therein. The inserting segment 11 is exposed from the insulation portion 22 of the body 2 to insert into a socket (not shown). The burying segment 12 is enclosed by the insulation portion 22 extending outward from the external surface of the body 2.

A plurality of drainage grooves 125 is disposed on the opposing first surfaces 121 of the burying segment 12. Hence, in addition to the barbs 124, the drainage grooves 125 are conducive to delivering the liquid plastic material to the filling space and filling the filling space with the liquid plastic material. The liquid plastic material sets and turns into the solid plastic material which is then fixed to the burying segment 12 by means of the drainage grooves 125, thereby allowing the pin 1 to be fixed to the body 2 more firmly.

A plurality of embedded grooves 126 is disposed on the two second surfaces 122 of the burying segment 12. The embedded grooves 126 are positioned proximate to the fixing segment 13. After ending up in the embedded grooves 126, the liquid plastic material sets and turns into the solid plastic material to be attached to the burying segment 12 firmly, thereby allowing the pin 1 to be fixed to the body 2 more firmly.

A portion of the inserting segment 11 and a portion of the fixing segment 13 are enclosed by the body 2. To fix the pin 1 to the body 2, the injection molding process involves: enclosing the burying segment 12, the portion of the inserting segment 11, and the portion of the fixing segment 13 by the injection molding die of the body 2; forming the plastic material-holding filling space between the injection molding die and the burying segment 12, the portion of the inserting segment 11, and the portion of the fixing segment 13; and filling the filling space with the liquid plastic material to enclose the burying segment 12, the portion of the inserting segment 11, and the portion of the fixing segment 13 with the body 2, thereby allowing the pin 1 to be fixed to the body 2 more firmly.

A fixing hole 132 is formed in the fixing segment 13 to penetrate the fixing segment 13 and open at the opposing first surfaces 131 of the fixing segment 13. The fixing hole 132 enables the fixing segment 13 to be fixed to the body 2 or connected to another component inside the body 2.

A through hole 112 is formed in the inserting segment 11 to penetrate the inserting segment 11 and open at the two opposing first surfaces 111 of the inserting segment 11. The through hole 112 enables the inserting segment 11 to be firmly coupled to a socket (not shown).

Referring to FIG. 6 through FIG. 10, there are shown perspective views of the plug 3 according to another embodiment of the present invention, a schematic view of a burying segment buried in an insulation portion, a schematic view of the insulation portion of the body, and a cross-sectional view of the insulation portion. Referring to FIG. 2 through FIG. 10, in the second aspect of the present invention, the plug 3 comprises the pin 1 and the body 2. The body 2 has a receiving space 21 therein for receiving the fixing segment 13. From its external surface, the body 2 extends outward to form the insulation portion 22. A fixing protruding portion 223 is disposed on each of the opposing first surfaces 221 inside the insulation portion 22. An inner barb 224 is formed between each of the opposing first surfaces 221 inside the insulation portion 22 and a corresponding one of two opposing surfaces 222 inside the insulation portion 22. In this embodiment, although four said inner barbs 224 are provided, the quantity of the inner barbs 224 is subject to changes as needed. The pin 1 is plate-shaped and is defined with the inserting segment 11, the fixing segment 13, and the burying segment 12 therebetween. The inserting segment 11, the burying segment 12, and the fixing segment 13 are flat. The thickness of the burying segment 12 is less than the thickness of the inserting segment 11, and the burying segment 12 adjoins the inserting segment 11; hence, a stepped structure is formed between each of two opposing first surfaces 111 of the inserting segment 11 which together define the thickness thereof and a corresponding one of two opposing first surfaces 121 of the burying segment 12 which together define the thickness thereof. The burial hole 123 is formed in the burying segment 12 to penetrate the burying segment 12 and open at the two opposing first surfaces 121 of the burying segment 12. The burial hole 123 is oblong and its length varies with that of the burying segment 12. The barbs 124 are formed between each said first surfaces 121 and each said second surfaces 122. In this embodiment, although four said barbs 124 are provided, the quantity of the barbs 124 is subject to changes as needed or equals the quantity of the inner barbs 224. The burying segment 12 is buried in the insulation portion 22. The fixing protruding portion 223 is disposed inside the burial hole 123. The inner barbs 224 are in seamless contact with the barbs 124, respectively. The thickness of the fixing segment 13 is larger than the thickness of the burying segment 12, and the fixing segment 13 adjoins the burying segment 12; hence, a stepped structure is formed between each of two opposing first surfaces 121 of the burying segment 12 and a corresponding one of two opposing first surfaces 131 of the fixing segment 13 which together define the thickness thereof.

An injection molding process for forming the pin 1 at the body 2 comprises the steps of: enclosing the burying segment 12 by an injection molding die (not shown) for the body 2; forming a filling space (not shown) adapted to contain a liquid plastic material therein between the burying segment 12 and the injection molding die; and filling the filling space with the liquid plastic material (not shown). With the burying segment 12 being equipped with the barbs 124, a relatively spacious flow channel is formed between the burying segment 12 and the injection molding die to allow the liquid plastic material to fill the filling space smoothly. Afterward, the liquid plastic material sets and turns into the solid plastic material for forming the insulation portion 22 at the periphery of the burying segment 12. With the burying segment 12 having the burial hole 123, a portion of the liquid plastic material fills the burial hole 123 and sets therein to become the fixing protruding portion 223. The fixing protruding portion 223 is fixed to the burial hole 123, thereby allowing the pin 1 to be fixed to the body 2 firmly. Due to the stepped structure formed between each of the two opposing first surfaces 121 of the burying segment 12 and a corresponding one of the two opposing first surfaces 111 of the inserting segment 11 and the stepped structure formed between each of the two opposing first surfaces 121 of the burying segment 12 and a corresponding one of the two opposing first surfaces 131 of the fixing segment 13, the liquid plastic material sets and forms the insulation portion 22, and thus the pin 1 is firmly fixed to the insulation portion 22 because of the stepped structures, thereby allowing the pin 1 to be fixed to the body 2 more firmly. Last but not least, the liquid plastic material sets and forms the body 2. Due to the barbs 124, the liquid plastic material sets and forms the insulation portion 22 at the periphery of the burying segment 12, such that the insulation portion 22 and the body 2 are integrally formed as a unitary structure. The fixing segment 13 protrudes into the body 2 to connect with other components (not shown) therein. The inserting segment 11 is exposed from the insulation portion 22 of the body 2 to insert into a socket (not shown). The burying segment 12 is enclosed by the insulation portion 22 extending outward from the external surface of the body 2.

A plurality of drainage grooves 125 is disposed on the opposing first surfaces 121 of the burying segment 12. A plurality of fixing ribs 225 is disposed on the opposing first surfaces 221 inside the insulation portion 22. The fixing ribs 225 are disposed in the drainage grooves 125, respectively. The drainage grooves 125 can be disposed on the two opposing first surfaces 121 of the burying segment 12, and the fixing ribs 225 can be disposed on the two opposing first surfaces 221 inside the insulation portion 22. Hence, in addition to the barbs 124, the drainage grooves 125 are conducive to delivering the liquid plastic material to the filling space and filling the filling space with the liquid plastic material. After the liquid plastic material in the drainage grooves 125 has set and formed the fixing ribs 225, the burying segment 12 is fixed to the insulation portion 22 by means of the drainage grooves 125 and the fixing ribs 225, thereby allowing the pin 1 to be fixed to the body 2 more firmly.

The embedded grooves 126 are disposed on the two second surfaces 122 of the burying segment 12. The embedded grooves 126 are positioned proximate to the fixing segment 13. A plurality of fixing bumps 226 is disposed on the two opposing surfaces 222 inside the insulation portion 22. The fixing bumps 226 are disposed inside the embedded grooves 126, respectively. The embedded grooves 126 can be disposed on the two second surfaces 122 of the burying segment 12, and the fixing bumps 226 can be disposed on the two opposing surfaces 222 inside the insulation portion 22. After ending up in the embedded grooves 126, the liquid plastic material sets and forms the fixing bumps 226. Afterward, the burying segment 12 is fixed to the insulation portion 22 by means of the embedded grooves 126 and the fixing bumps 226, thereby allowing the pin 1 to be fixed to the body 2 more firmly.

The aforesaid portion of the inserting segment 11 and the aforesaid portion of the fixing segment 13 are enclosed by the insulation portion 22. To fix the pin 1 to the body 2, the injection molding process involves: enclosing the burying segment 12, the portion of the inserting segment 11, and the portion of the fixing segment 13 by the injection molding die of the body 2; forming the plastic material-holding filling space between the injection molding die and the burying segment 12, the portion of the inserting segment 11, and the portion of the fixing segment 13; and filling the filling space with the liquid plastic material to enclose the burying segment 12, the portion of the inserting segment 11, and the portion of the fixing segment 13 with the body 2, thereby allowing the pin 1 to be fixed to the body 2 more firmly.

The fixing hole 132 is formed in the fixing segment 13 to penetrate the fixing segment 13 and open at the opposing first surfaces 131 of the fixing segment 13. The fixing hole 132 enables the fixing segment 13 to be fixed to the body 2 or connected to another component inside the body 2.

The through hole 112 is formed in the inserting segment 11 to penetrate the inserting segment 11 and open at the two opposing first surfaces 111 of the inserting segment 11. The through hole 112 enables the inserting segment 11 to be firmly coupled to a socket (not shown).

The present invention is disclosed above by preferred embodiments. However, persons skilled in the art should understand that the preferred embodiments are illustrative of the present invention only, but should not be interpreted as restrictive of the scope of the present invention. Hence, all equivalent modifications and replacements made to the aforesaid embodiments should fall within the scope of the present invention. Accordingly, the legal protection for the present invention should be defined by the appended claims.

What is claimed is:

1. A pin, disposed at a body and plate-shaped, the pin being characterized in that:
the pin is defined with an inserting segment, a fixing segment, and a burying segment therebetween, and the burying segment has a burial hole and barbs and is enclosed by an outward-extending external surface of the body.

2. The pin of claim 1, wherein the burying segment has drainage grooves.

3. The pin of claim 1, wherein the burying segment has a plurality of embedded grooves positioned proximate to the fixing segment.

4. The pin of claim 1, wherein the fixing segment has a fixing hole.

5. The pin of claim 1, wherein the inserting segment has a through hole.

6. The pin of claim 1, wherein thickness of the fixing segment is larger than thickness of the burying segment.

7. The pin of claim 1, wherein thickness of the burying segment is less than thickness of the inserting segment.

8. A plug, comprising:
a body having a receiving space therein for receiving the fixing segment, and an insulation portion extending outward from an external surface of the body; and
a pin being plate-shaped and defined with an inserting segment, a fixing segment, and a burying segment therebetween, the burying segment having a burial hole and barbs and being buried in the insulation portion.

9. The plug of claim 8, wherein the burying segment has drainage grooves, and the insulation portion has fixing ribs disposed inside the drainage grooves, respectively.

10. The plug of claim 9, wherein the burying segment has embedded grooves, and the insulation portion has fixing bumps disposed inside the embedded grooves, respectively.

11. The plug of claim 8, wherein the fixing segment has a fixing hole.

12. The plug of claim 8, wherein the inserting segment has a through hole.
